(19) United States
(12) Patent Application Publication
(10) Pub. No.: US 2026/0126590 A1
(43) Pub. Date: May 7, 2026

(54) QUANTUM DEVICE AND METHOD FOR MANUFACTURING QUANTUM DEVICE

(71) Applicant: FUJITSU LIMITED, Kawasaki-shi, Kanagawa (JP)

(72) Inventors: Tetsuro ISHIGURO, Kawasaki (JP); Tetsuya MIYATAKE, Isehara (JP); Toshiki IWAI, Atsugi (JP); Kenichi KAWAGUCHI, Ebina (JP); Yoshiyasu DOI, Yokohama (JP); Shintaro SATO, Atsugi (JP)

(73) Assignee: FUJITSU LIMITED, Kawasaki-shi, Kanagawa (JP)

(21) Appl. No.: 18/950,250

(22) Filed: Nov. 18, 2024

Related U.S. Application Data
(63) Continuation of application No. PCT/JP2022/021961, filed on May 30, 2022.

(51) Int. Cl. G02B 6/293

(52) U.S. Cl. CPC G02B 6/29338

(57) ABSTRACT

A quantum device includes a first waveguide, an optical resonator that is coupled to the first waveguide, a first light source that introduces first light into the first waveguide, and a second light source that irradiates the optical resonator with second light. The optical resonator includes a second waveguide extending in a first direction and a color center provided in the second waveguide. The second light source has an optical axis in a second direction perpendicular to the first direction, and the color center is irradiated with the second light.

### CROSS-REFERENCE TO RELATED APPLICATION

This application is a continuation application of International Application PCT/JP2022/021961 filed on May 30, 2022 and designated the U.S., the entire contents of which are incorporated herein by reference.

### FIELD

The embodiments discussed herein are related to a quantum device and a method for manufacturing a quantum device.

### BACKGROUND

In recent years, research and development of quantum computers have been vigorously advanced. For example, a quantum computer that uses a level of an electron spin of a color center of diamond as a qubit is known. In such quantum computer, information of electron spin is converted into information of photon, and optical reading is performed.

Example of the related art include: [PTL 1] Japanese Laid-open Patent Publication No. 2014-216596; [PTL 2] International Publication Pamphlet No. WO 2020/203746; and [NPL 1] Kazuki Koshino and three others, “Deterministic Quantum State Switching by Single Photon”, Journal of the Physical Society of Japan, Vol. 1, No. 1, 2014.

### SUMMARY

According to an aspect of the embodiments, there is provided a quantum device including: a first waveguide; an optical resonator that is coupled to the first waveguide; a first light source that introduces first light into the first waveguide; and a second light source that irradiates the optical resonator with second light, wherein the optical resonator includes a second waveguide that extends in a first direction and a color center that is provided in the second waveguide, the second light source has an optical axis in a second direction perpendicular to the first direction, and the color center is irradiated with the second light.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a plan view illustrating a quantum device according to a first embodiment.

FIG. 2 is a cross-sectional view illustrating the quantum device according to the first embodiment.

FIG. 3 is a diagram illustrating an example of the operation of the quantum device according to the first embodiment.

FIG. 4 is a diagram illustrating another example of the operation of the quantum device according to the first embodiment.

FIG. 5 is a diagram illustrating a relationship between parameter (Ωd/χ) and γmn/γ (m is 3 or 4, and n is 1 or 2).

FIG. 6 is a perspective view illustrating a method for manufacturing an optical resonator in the quantum device according to the first embodiment (part 1).

FIG. 7 is a perspective view illustrating the method for manufacturing an optical resonator in the quantum device according to the first embodiment (part 2).

FIG. 8 is a perspective view illustrating the method for manufacturing an optical resonator in the quantum device according to the first embodiment (part 3).

FIG. 9 is a perspective view illustrating the method for manufacturing an optical resonator in the quantum device according to the first embodiment (part 4).

FIG. 10 is a perspective view illustrating the method for manufacturing an optical resonator in the quantum device according to the first embodiment (part 5).

FIG. 11 is a diagram illustrating a calculation result of electromagnetic field distribution related to the first embodiment.

FIG. 12 is a diagram illustrating an intensity profile of a standing wave extracted in the vicinity of a color center.

FIG. 13 is a plan view illustrating a quantum device according to a second embodiment.

FIG. 14 is a plan view illustrating a quantum device according to a third embodiment.

FIG. 15 is a diagram illustrating a quantum computation apparatus according to a fourth embodiment.

### DESCRIPTION OF EMBODIMENTS

Optical transition used for reading a state occurs probabilistically based on the selection rule of quantum mechanics. Consequently, it is difficult for a conventional quantum device used in a quantum computer to convert information of electron spin into information of photon with high efficiency.

An object of the present disclosure is to provide a quantum device capable of improving conversion efficiency of information of electron spin into information of photon, and a method for manufacturing a quantum device.

Hereinafter, embodiments of the present disclosure will be specifically described with reference to the attached drawings. Note that, in the present specification and drawings, redundant description may be omitted by giving the same reference sign for constituent elements having substantially the same functional configuration. In the present disclosure, an X1-X2 direction, a Y1-Y2 direction, and a Z1-Z2 direction are directions orthogonal to one another. A plane including the X1-X2 direction and the Y1-Y2 direction is described as an XY plane, a plane including the Y1-Y2 direction and the Z1-Z2 direction is described as a YZ plane, and a plane including the Z1-Z2 direction and the X1-X2 direction is described as a ZX plane. Note that, for convenience, the Z1-Z2 direction is an up-down direction, a Z1 side is an upper side, and a Z2 side is a lower side. Further, a plan view refers to viewing a target object from the Z1 side, and a planar shape refers to the shape of a target object as viewed from the Z1 side.

### First Embodiment

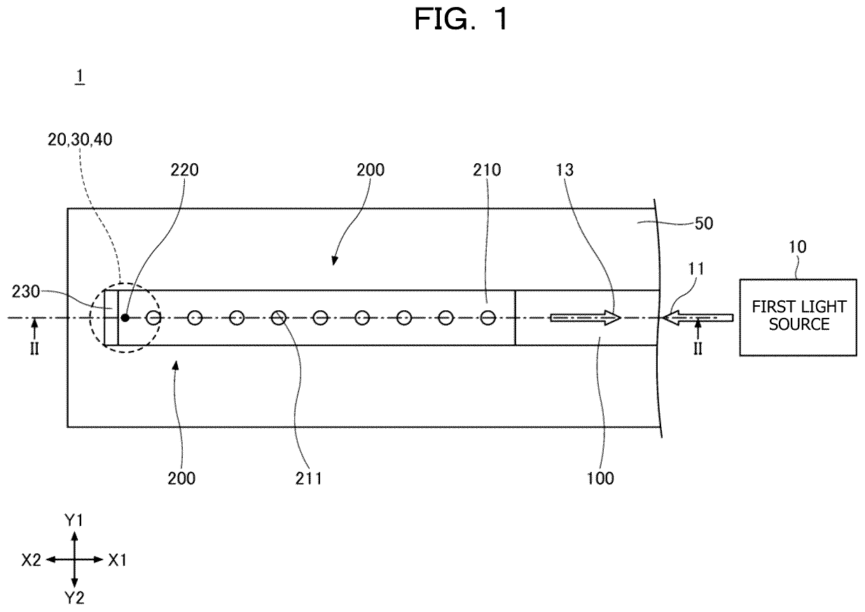

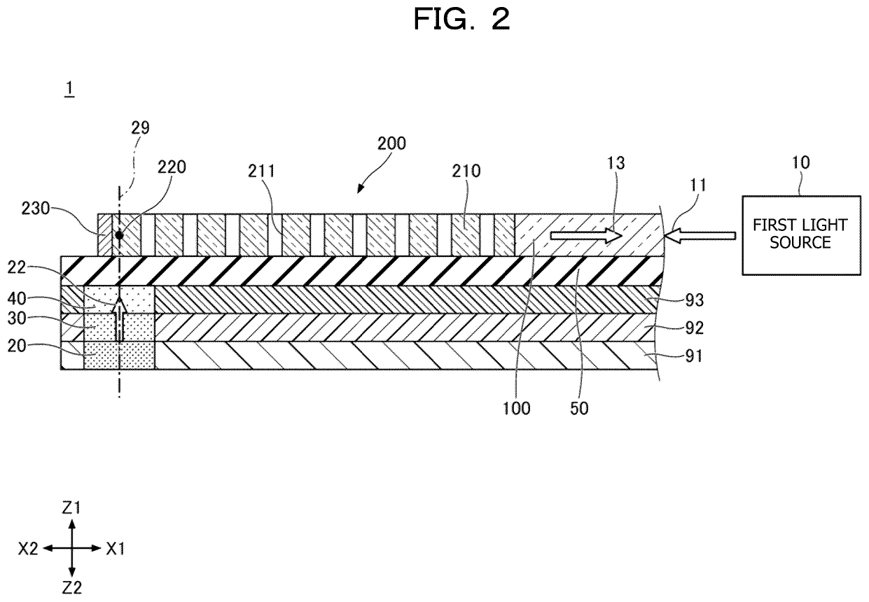

A first embodiment will be described. FIG. 1 is a plan view illustrating a quantum device according to the first embodiment. FIG. 2 is a cross-sectional view illustrating the quantum device according to the first embodiment. FIG. 2 corresponds to a cross-sectional view along line I-I in FIG. 1.

A quantum device 1 according to the first embodiment mainly includes a first waveguide 100, an optical resonator 200, a first light source 10, a second light source 20, a static magnetic field source 30, and a microwave source 40. The second light source 20 is provided in a printed wiring board 91, the static magnetic field source 30 is provided in a printed wiring board 92, and the microwave source 40 is provided in a printed wiring board 93.

The printed wiring board 92 is provided over the printed wiring board 91, and the printed wiring board 93 is provided over the printed wiring board 92. The static magnetic field source 30 is positioned above the second light source 20, and the microwave source 40 is positioned above the static magnetic field source 30. The second light source 20, the static magnetic field source 30, and the microwave source 40 overlap each other in the Z1-Z2 direction. The second light source 20 has an optical axis 29 in the Z1-Z2 direction. For example, the second light source 20 is a coherent light source. The Z1-Z2 direction is an example of a second direction. The stacking order of the printed wiring boards 91, 92, and 93 is not limited to the above-described order.

A board 50 is provided over the printed wiring board 93, and the first waveguide 100 and the optical resonator 200 are provided over the board 50. The board 50 supports the first waveguide 100 and the optical resonator 200. The refractive index of the material of the board 50 is lower than the refractive index of diamond. For example, the material of the board 50 is silicon oxide (SiO₂) or sapphire.

The optical resonator 200 includes a second waveguide 210 extending in the X1-X2 direction. The second waveguide 210 includes diamond including a color center 220. For example, the second waveguide 210 is made of diamond including the color center 220. The color center 220 is provided at an end portion of the second waveguide 210 on the X2 side. For example, the color center 220 is provided at a position away from an end surface of the second waveguide 210 on the X2 side toward the X1 side by about several 10 nm. The color center 220 is over the optical axis 29. Therefore, the color center 220 is irradiated with second light 22 emitted by the second light source 20. For example, the color center 220 is a nitrogen-vacancy center (NV center) composed of nitrogen and a vacancy. The color center 220 may be a silicon-vacancy center (SiV center) composed of silicon and vacancies, a germanium-vacancy center (GeV center) composed of germanium and vacancies, a tin-vacancy center (SnV center) composed of tin and vacancies, a lead-vacancy center (PbV center) composed of lead and vacancies, or a boron-vacancy center (BV center) composed of boron and a vacancy. The board 50 is an example of a support. The X1-X2 direction is an example of a first direction.

In the second waveguide 210, a plurality of openings 211 arranged in the X1-X2 direction is formed at equal intervals. The openings 211 penetrate the second waveguide 210 in the Z1-Z2 direction. The openings 211 function as a mirror. Further, the optical resonator 200 includes a reflective film 230 that covers the end surface of the second waveguide 210 on the X2 side. The reflective film 230 is a metal film having a high reflectance with respect to visible light. For example, the reflective film 230 is an Ag film having a thickness of about several 10 nm. The reflective film 230 suppresses emission of light in the optical resonator 200 from the end surface on the X2 side.

The first waveguide 100 is coupled to an end portion of the second waveguide 210 on the X1 side. The first waveguide 100 extends in the X1-X2 direction. The first waveguide 100 includes a nitride semiconductor, for example, AlN, which has a lower refractive index and a lower absorptance in the visible light range than diamond. For example, the first waveguide 100 is made of AlN. The first light source 10 irradiates the first waveguide 100 with first light 11. For example, the first light source 10 is a quantum light source.

In the present embodiment, the following relationship holds. Coupling coefficient g of the optical resonator 200 is smaller than the absolute value of a difference between resonance frequency ω_{c} of the optical resonator 200 and light emission frequency ωₐ of the color center 220 (|ω_{c}−ωₐ|). Frequency ω_{d} of the second light 22 is equal to ωₐ−2χ. Here, χ is g²/(ω_{c}−ωₐ).

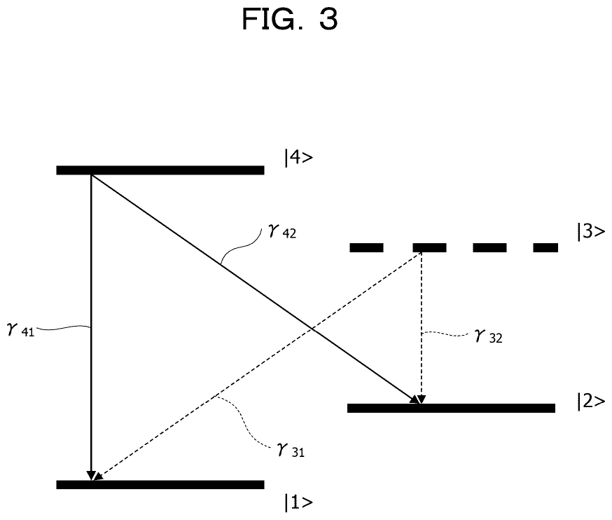

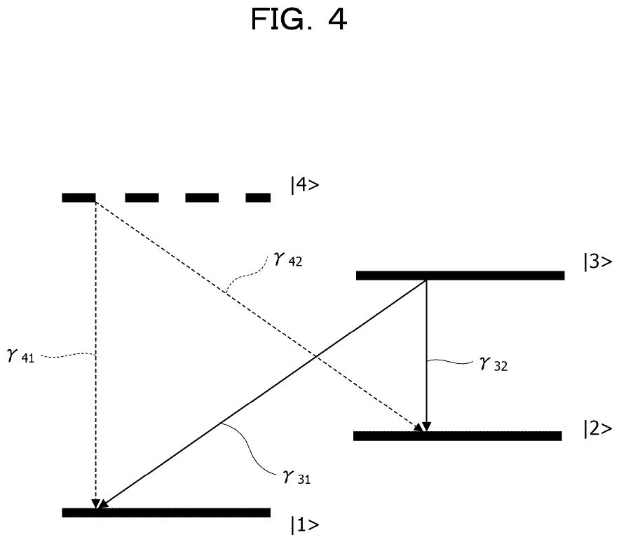

Next, the operation of the quantum device 1 according to the first embodiment will be described. FIG. 3 is a diagram illustrating an example of the operation of the quantum device 1 according to the first embodiment. FIG. 4 is a diagram illustrating another example of the operation of the quantum device 1 according to the first embodiment.

In the quantum device 1, the first light 11 is introduced from the first light source 10 into the first waveguide 100, and the first light 11 reaches the color center 220. The color center 220 forms, in the band gap, a spin level (spin triplet) that is energetically discretized at a frequency of the order of GHz corresponding to the spin quantum number 1 of itself. In this case, when a spin level of which spin magnetic quantum number is 0 and a spin level of which spin magnetic quantum number is −1 are regarded as qubits, spin 0 indicates a light absorption-emission process between ground and excitation levels in the visible light range, that is, a process of emission relaxation. On the other hand, spin −1 indicates a process of non-emission relaxation to the ground level of spin 0 through a metastable state (spin singlet) of spin 0. That is, by measuring photon information (the presence or absence of photon emission) emitted after optical excitation within a time scale in which the coherence of a state is held after state operation by a microwave to a qubit level, reading of a qubit through a photon (spin-photon conversion) may be performed.

Further, with respect to transition between ground and excitation levels for emission relaxation, two systems of two-level systems represented by four levels of |g, 0>, |g, 1>, |e, 0>, and |e, 1> are formed based on the Jaynes-Cummings model. Here, g represents a ground level of emission relaxation, e represents an excitation level of emission relaxation, and 0 or 1 represents the number of photons in the optical resonator 200. With the second light 22 (external control light), these two systems of two-level systems form dressed levels including four levels of |1>, |2>, |3>, and |4> as illustrated in FIG. 3 and FIG. 4. The two levels |1> and |2> are levels of the color center 220 itself, and |3> and |4> are levels formed by irradiation with the second light 22. Here, the relaxation rate from the level |4> to the level |1> is γ₄₁, the relaxation rate from the level |4> to the level |2> is γ₄₂, the relaxation rate from the level |3> to the level |1> is γ₃₁, and the relaxation rate from the level |3> to the level |2> is γ₃₂. In this case, γ=γ₃₁+γ₃₂=γ₄₁+γ₄₂ holds. When the intensity of the second light 22 is Ω_{d}, γ₃₁, γ₃₂, γ₄₁, and γ₄₂ are represented as follows.

$${γ}_{32} / γ = {γ}_{41} / γ = {cos}^{2} ( {tan}^{- 1} ( 2 {Ω}_{d} / χ ) )$$

$${γ}_{31} / γ = {γ}_{42} / γ = {sin}^{2} ( {tan}^{- 1} ( 2 {Ω}_{d} / χ ) )$$

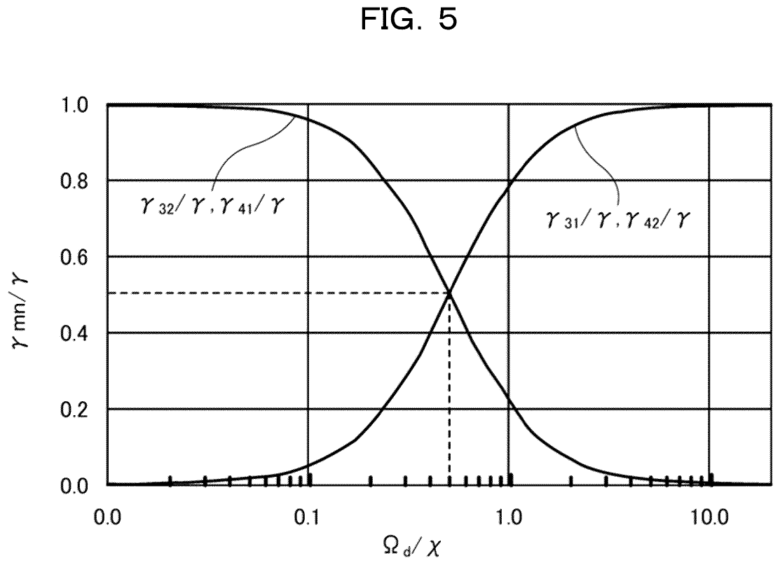

FIG. 5 illustrates a relationship between parameter (Ω_{d}/χ) and γₘₙ/γ (m is 3 or 4, and n is 1 or 2). Here, assuming that the color center 220 is an NV center, ωₐ=2.959×10¹⁵ rad/s (637 nm), ω_{c}=ωₐ+10¹⁰ (1.6 GHz), g=10¹⁰ rad/s, χ=10⁶ rad/s, Ω_{d}=5×10⁵ rad/s, and γ=2.4×10³ rad/s. 637 nm is the wavelength corresponding to light emission frequency ωₐ of the color center, and 1.6 GHz is the frequency of the resonator. As illustrated in FIG. 5, when parameter (Ω_{d}/χ) is 0.5, γ₃₁/γ, γ₃₂/γ, γ₄₁/γ, and γ₄₂/γ are equal to each other. That is, when parameter (Ω_{d}/χ) is 0.5, at least relaxation rate γ₃₁ and relaxation rate γ₃₂ are equal to each other, or relaxation rate γ₄₁ and relaxation rate γ₄₂ are equal to each other. Further, when coupling coefficient g and volume gω_{c}Vₘ of the optical resonator 200 are taken into consideration, the value of Q represented by (2g²/kγ)×(4π²/3λ³)×Vₘ is about 500. This indicates that highly efficient spin-photon conversion is performed. Ultimately, on-demand (deterministic) optical spin-photon conversion may be possible. Note that k and λ represent a relaxation rate and a resonance wavelength of the resonator, respectively.

In the present embodiment, in the example illustrated in FIG. 3, spin-photon conversion is performed focusing on a Λ-type three-level system using the three levels of |1>, |2>, and |4> without using the level |3>. Further, in the example illustrated in FIG. 4, spin-photon conversion is performed focusing on the Λ-type three-level system using the three levels of |1>, |2>, and |3> without using the level |4>. When spin-photon conversion is performed, the static magnetic field source 30 generates a static magnetic field that reaches the color center 220, and the microwave source 40 generates a microwave that reaches the color center 220. Third light 13 (inelastically scattered light) having a wavelength different from that of the first light 11 is output from the optical resonator 200 to the first waveguide 100. By observing the third light 13, the state of the color center 220 may be grasped.

As described above, in the first embodiment, transition between ground and excitation levels of one of the spin levels constituting a qubit in the color center 220, which undergoes emission relaxation with respect to the first light 11 (readout light) introduced into the color center 220, is coupled to the optical resonator 200. Further, relaxation rate control is performed on the three-level system formed by application of the second light 22 (external control light). As a result, two relaxation rates from the excitation level to the ground level in the three-level system become equal to each other, and the efficiency of spin-photon conversion may be improved. That is, conversion efficiency of information of electron spin into information of photon may be improved.

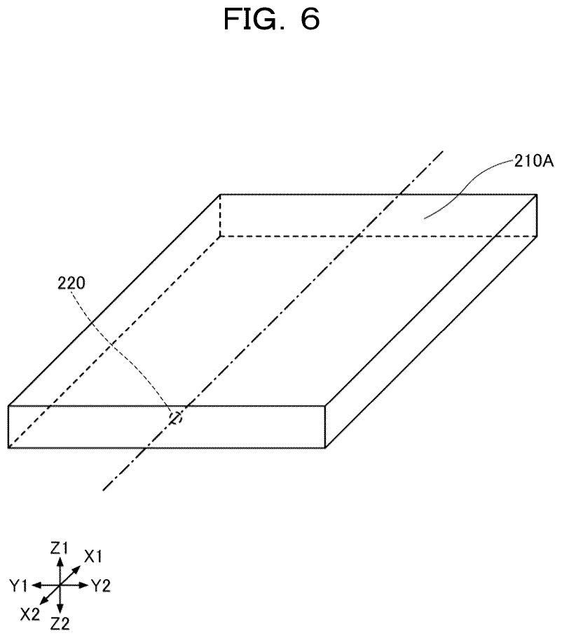

Next, a method for manufacturing the optical resonator 200 will be described. FIG. 6 to FIG. 10 are perspective views illustrating the method for manufacturing the optical resonator 200 in the quantum device 1 according to the first embodiment.

First, as illustrated in FIG. 6, a thin diamond board 210A serving as a base member of the second waveguide 210 is prepared, and the diamond board 210A is cleaned. Next, the color center 220 is formed by implanting a desired element species, for example, nitrogen by the ion implantation method or the like and performing annealing (activation treatment).

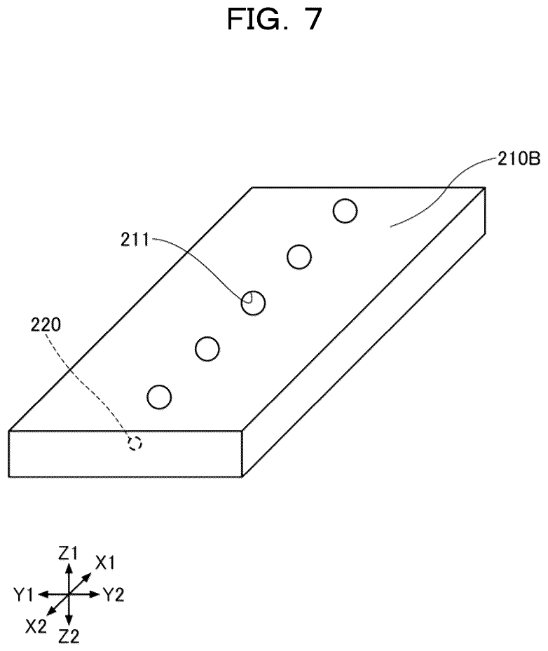

Thereafter, as illustrated in FIG. 7, a diamond board 210B closer to the size of the second waveguide 210 than the diamond board 210A is obtained by processing by the focused ion beam (FIB) method or the like and forming the openings 211.

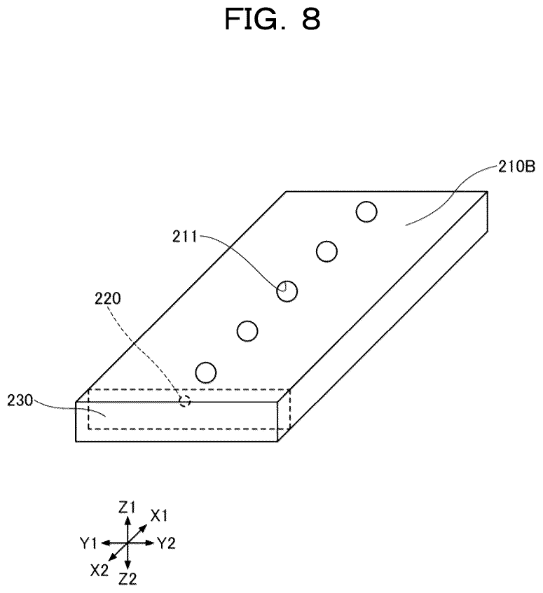

Subsequently, as illustrated in FIG. 8, the reflective film 230 is formed by the vapor deposition method or the like so as to cover an end surface of the diamond board 210B on the X2 side.

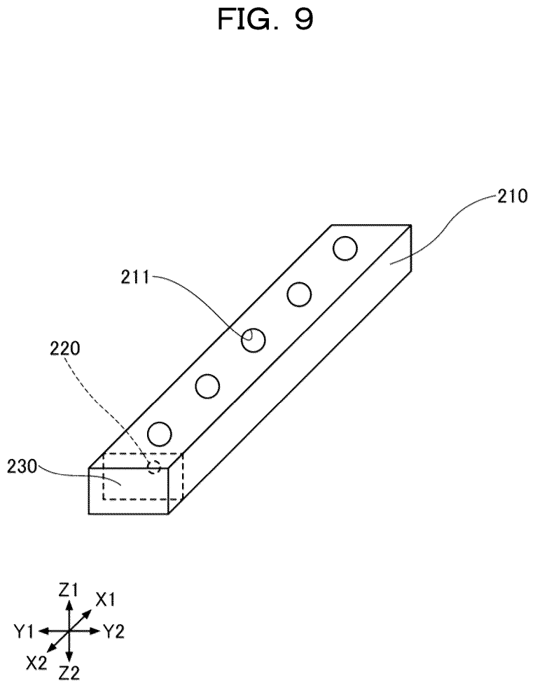

Next, as illustrated in FIG. 9, the diamond board 210B is processed by FIB or the like, and the second waveguide 210 is obtained.

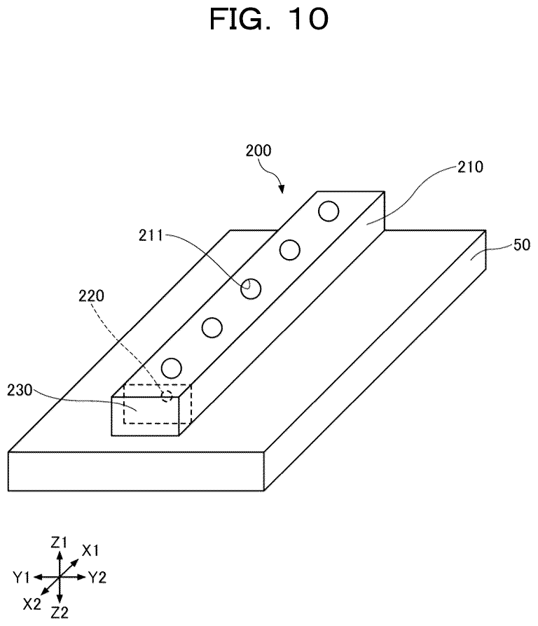

Thereafter, as illustrated in FIG. 10, the second waveguide 210 is bonded over the board 50. For example, the first waveguide 100 is formed over the board 50 in advance.

In this way, the optical resonator 200 may be manufactured.

When the quantum device 1 is manufactured, the printed wiring board 91 including the second light source 20, the printed wiring board 92 including the static magnetic field source 30, and the printed wiring board 93 including the microwave source 40 are stacked. Then, the board 50 provided with the first waveguide 100 and the optical resonator 200 (see FIG. 10) is provided over the printed wiring board 93. The first light source 10 may be coupled to the first waveguide 100 in advance, or may be coupled to the first waveguide 100 after the board 50 is provided over the printed wiring board 93.

Here, a calculation result of electromagnetic field distribution related to the first embodiment will be described. In this calculation, assuming that the color center 220 is an NV center, electromagnetic field distribution in the optical resonator 200 under the following sizes (structural parameters) was obtained.

The distance between the end surface of the second waveguide 210 on the X2 side and the color center 220 is 25 nm. The reflective film 230 is an Ag film having a thickness of 10 nm. The diameter of the openings 211 is 100 nm. The pitch of the openings 211 is 200 nm. The length (size in the X1-X2 direction) of the second waveguide 210 is 2000 nm. The width (size in the Y1-Y2 direction) of the second waveguide 210 is 280 nm. The height (size in the Z1-Z2 direction) of the second waveguide 210 is 120 nm.

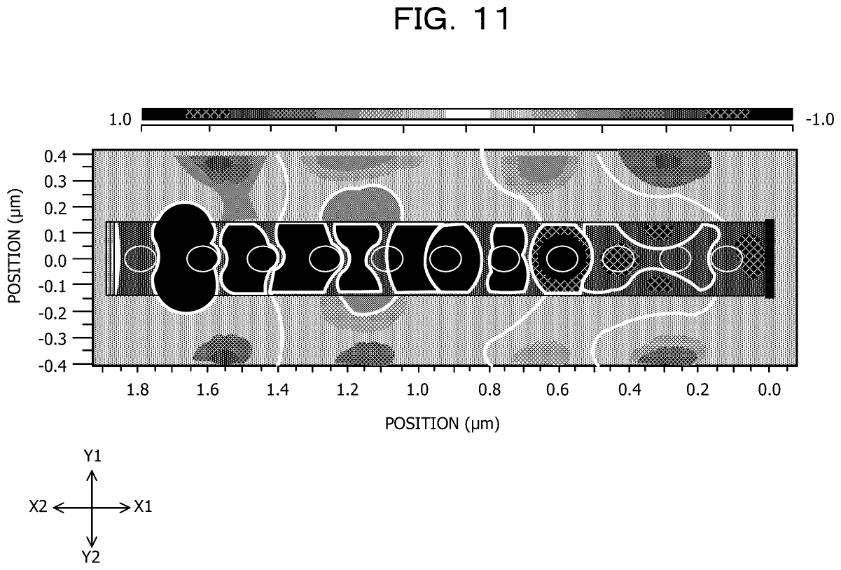

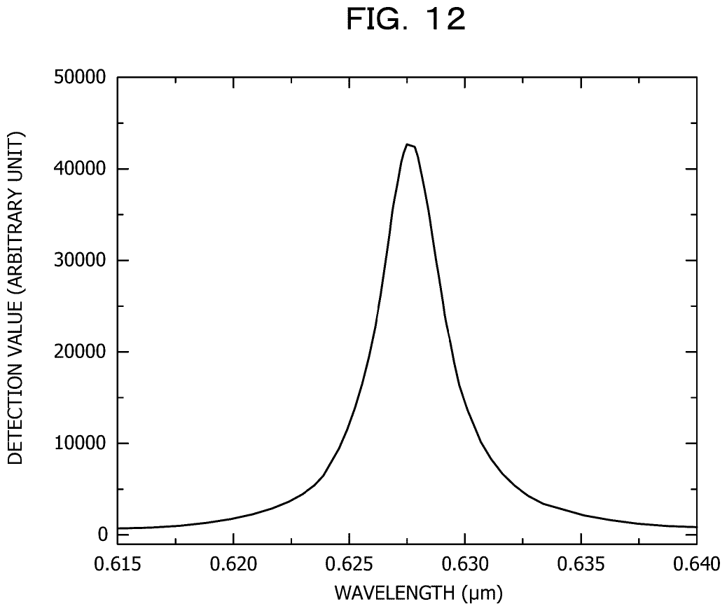

FIG. 11 illustrates a calculation result of electromagnetic field distribution related to the first embodiment. The intensity of an electromagnetic field is standardized. With reference to an end surface of the optical resonator 200 on the X1 side, the horizontal axis in FIG. 11 indicates a position with the X2 side being positive. With reference to the center of the optical resonator 200 in the Y1-Y2 direction, the vertical axis in FIG. 11 indicates a position with the Y1 side being positive. As illustrated in FIG. 11, since the reflective film 230 is provided, release of energy to the X2 side of the reflective film 230 is suppressed. Further, a standing wave having a relatively high electromagnetic field intensity is formed at the position of the color center 220. FIG. 12 illustrates an intensity profile of a standing wave extracted in the vicinity of the color center 220. The value of Q of the optical resonator 200 estimated from the intensity profile illustrated in FIG. 12 is 520. This indicates that highly efficient spin-photon conversion is performed. In general, if the value of Q is about 500, on-demand (deterministic) generation of photons is possible. Therefore, this calculation result of electromagnetic field distribution suggests that on-demand (deterministic) generation of photons is possible with the quantum device 1 according to the first embodiment.

### Second Embodiment

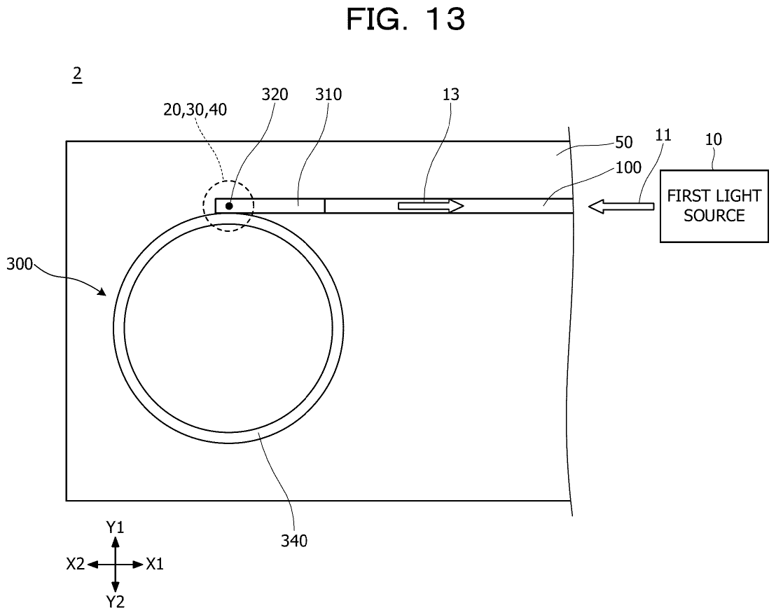

A second embodiment will be described. FIG. 13 is a plan view illustrating a quantum device according to the second embodiment.

A quantum device 2 according to the second embodiment includes an optical resonator 300 instead of the optical resonator 200. The optical resonator 300 includes a second waveguide 310 extending in the X1-X2 direction and a ring resonator 340.

As with the second waveguide 210, the second waveguide 310 includes diamond including a color center 320. For example, the second waveguide 310 is made of diamond including the color center 320. The color center 320 is provided at an end portion of the second waveguide 310 on the X2 side. For example, the color center 320 is provided at a position away from an end surface of the second waveguide 310 on the X2 side toward the X1 side by about several 10 nm. As with the color center 220, the color center 320 is over the optical axis 29 (see FIG. 2). Therefore, the color center 320 is irradiated with the second light 22 emitted by the second light source 20. For example, the color center 320 is an NV center, an SiV center, a GeV center, an SnV center, a PbV center, or a BV center. Unlike the second waveguide 210, openings are not formed in the second waveguide 310.

The ring resonator 340 includes diamond. For example, the ring resonator 340 is made of diamond. The ring resonator 340 is coupled to a portion of the second waveguide 310 where the color center 320 is provided.

Other configurations are similar to those of the first embodiment.

In the second embodiment, the electromagnetic field distribution of eigenmode in the ring resonator 340 is reflected in the second waveguide 310, and the electromagnetic field intensity increases in the vicinity of the color center 320. Consequently, the interaction between the color center 320 and the electromagnetic field is enhanced. That is, absorption and emission of light by the color center 320 are enhanced. Also, by the second embodiment, as with the first embodiment, conversion efficiency of information of electron spin into information of photon may be improved.

### Third Embodiment

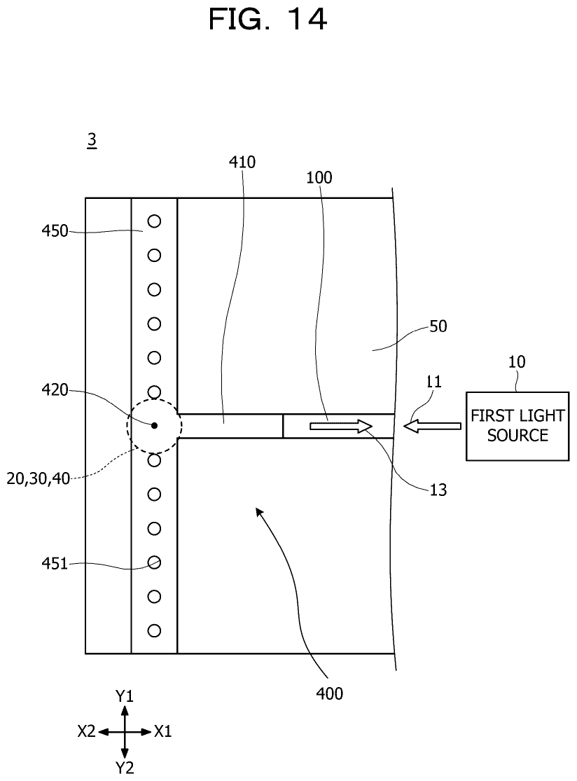

A third embodiment will be described. FIG. 14 is a plan view illustrating a quantum device according to the third embodiment.

A quantum device 3 according to the third embodiment includes an optical resonator 400 instead of the optical resonator 200. The optical resonator 400 includes a second waveguide 410 extending in the X1-X2 direction and a third waveguide 450 extending in the Y1-Y2 direction.

As with the second waveguide 210, the second waveguide 410 includes diamond including a color center 420. For example, the second waveguide 410 is made of diamond including the color center 420. The color center 420 is provided at an end portion of the second waveguide 410 on the X2 side. For example, the color center 420 is provided at a position away from an end surface of the second waveguide 410 on the X2 side toward the X1 side by about several 10 nm. As with the color center 220, the color center 420 is over the optical axis 29 (see FIG. 2). Therefore, the color center 420 is irradiated with the second light 22 emitted by the second light source 20. For example, the color center 420 is an NV center, an SiV center, a GeV center, an SnV center, a PbV center, or a BV center. Unlike the second waveguide 210, openings are not formed in the second waveguide 410.

The third waveguide 450 includes diamond. For example, the third waveguide 450 is made of diamond. The third waveguide 450 is orthogonal to the second waveguide 410 in a T-shape. The third waveguide 450 includes a portion extending from the intersection with the second waveguide 410 toward the Y1 side and a portion extending toward the Y2 side. The color center 420 may also be included in the third waveguide 450. In the third waveguide 450, a plurality of openings 451 arranged in the Z1-Z2 direction is formed at equal intervals. The openings 451 penetrate the third waveguide 450 in the Z1-Z2 direction. The openings 451 function as a mirror.

Other configurations are similar to those of the first embodiment.

In the third embodiment, the electromagnetic field distribution of eigenmode in the third waveguide 450 is reflected in the second waveguide 410, and the electromagnetic field intensity increases in the vicinity of the color center 420. Consequently, the interaction between the color center 420 and the electromagnetic field is enhanced. That is, absorption and emission of light by the color center 420 are enhanced. Also, by the third embodiment, as with the first embodiment, conversion efficiency of information of electron spin into information of photon may be improved.

### Fourth Embodiment

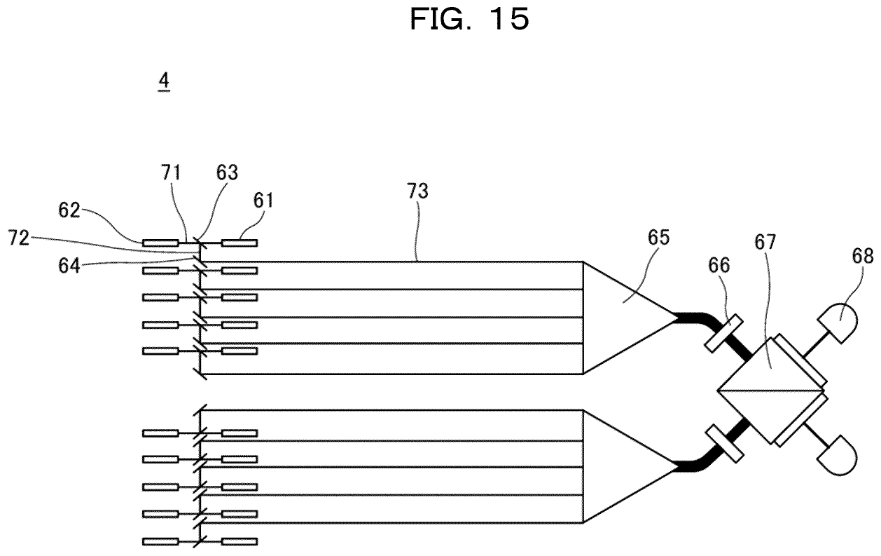

A fourth embodiment will be described. FIG. 15 is a diagram illustrating a quantum computation apparatus according to the fourth embodiment.

A quantum computation apparatus 4 according to the fourth embodiment includes one beam splitter 67, two detectors 68, two wavelength filters 66, and two multiplexers 65. One ends of four waveguides 73 are coupled to each multiplexer 65, a half mirror 64 is provided at the other ends of the waveguides 73, and one end of a waveguide 72 is coupled to the half mirror 64. A waveguide 71 is coupled to the other end of the waveguide 72 in a T-shape. A first light source 61 is coupled to one end of the waveguide 71, and an optical resonator 62 is coupled to the other end. A dielectric mirror 63 is provided at the intersection between the waveguide 71 and the waveguide 72. For example, the first light source 10 is used as the first light source 61. For example, the optical resonator 200, 300, or 400 is used as the optical resonator 62. Although illustration is omitted, as with the first, second, or third embodiment, the second light source 20, the static magnetic field source 30, and the microwave source 40 are provided below the optical resonator 62. For example, the first waveguide 100 is used as the waveguide 71.

As described above, in the fourth embodiment, the structures of the first, second, or third embodiment are arranged in parallel.

When one qubit operation is performed, after the state operation on a color center (qubit) by a microwave, first light (readout light) is incident on the optical resonator 62 through the dielectric mirror 63. Further, the color center is irradiated with second light from a second light source. The first light is reflected by the optical resonator 62, and third light (photon) is output. The third light (photon) is reflected by the dielectric mirror 63 toward the waveguide 72, and is detected by the detector 68 through the half mirror 64, the waveguide 73, the multiplexer 65, the wavelength filter 66, and the beam splitter 67.

When two qubit operation is performed, the third light (photon) output from one multiplexer 65 and the third light (photon) output from the other multiplexer 65 are correlated by the beam splitter 67. By observing the two photons with the detectors, an entangled state between qubits may be formed through the photons.

As described above, a combination of arbitrary gate operation of one qubit and two qubit gate operation enables universal quantum computation. Therefore, according to the present embodiment, a general-purpose type quantum computer using a color center of diamond may be configured.

Although the preferred embodiments and the like have been described in detail above, the present disclosure is not limited to the embodiments and the like described above. Various modifications and replacements may be made to the embodiments and the like described above without departing from the scope of the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A quantum device comprising:
a first waveguide;
an optical resonator that is coupled to the first waveguide;
a first light source that introduces first light into the first waveguide; and
a second light source that irradiates the optical resonator with second light,
wherein
the optical resonator includes a second waveguide that extends in a first direction and a color center that is provided in the second waveguide,
the second light source has an optical axis in a second direction perpendicular to the first direction, and
the color center is irradiated with the second light.

2. The quantum device according to claim 1, wherein third light of which wavelength is different from that of the first light is output from the optical resonator to the first waveguide.

3. The quantum device according to claim 1, wherein
the color center is provided at one end portion of the second waveguide, and
the first waveguide is coupled to the other end portion of the second waveguide.

4. The quantum device according to claim 1, wherein the device includes
a static magnetic field source that generates a magnetic field that reaches the color center, and
a microwave source that generates a microwave that reaches the color center.

5. The quantum device according to claim 1, wherein the color center includes a composite defect of N, Si, Ge, Sn, or Pb, or arbitrary combination thereof, and a vacancy.

6. The quantum device according to claim 1, wherein material of the second waveguide is diamond, and a refractive index of material of the first waveguide is lower than a refractive index of diamond.

7. The quantum device according to claim 1, wherein
the first light source is a quantum light source, and
the second light source is a coherent light source.

8. The quantum device according to claim 1, wherein a plurality of openings arranged in the first direction is formed at equal intervals in the second waveguide.

9. The quantum device according to claim 1, wherein a coupling coefficient of the optical resonator is smaller than an absolute value of a difference between a resonance frequency of the optical resonator and a light emission frequency of the color center.

10. The quantum device according to claim 1, wherein
the first light source is a coherent light source, and
when a light intensity of the second light source is Ωd, a coupling coefficient of the optical resonator is g, a resonance frequency of the optical resonator is ω_{c}, and a light emission frequency of the color center is ωₐ,
$$χ = {g}^{2} / ( {ω}_{c} - {ω}_{a} ) and$$
$${cos}^{2} ( {tan}^{- 1} ( 2 {Ω}_{d} / χ ) ) = {sin}^{2} ( {tan}^{- 1} ( 2 {Ω}_{d} / χ ) )$$
are satisfied.

11. The quantum device according to claim 10, wherein a frequency of the second light is equal to ωₐ−2χ.

12. The quantum device according to claim 1, wherein the device includes a support that supports the first waveguide and the optical resonator.

13. The quantum device according to claim 12, wherein a refractive index of material of the support is lower than a refractive index of diamond.

14. A method for manufacturing a quantum device comprising:
a step of providing an optical resonator that is coupled to a first waveguide;
a step of providing a first light source that introduces first light into the first waveguide; and
a step of providing a second light source that irradiates the optical resonator with second light,
wherein
the optical resonator includes a second waveguide that extends in a first direction and a color center that is provided in the second waveguide, and
the second light source has an optical axis in a second direction perpendicular to the first direction, and is disposed such that the color center is irradiated with the second light.

15. A quantum computation apparatus comprising a quantum device,
the quantum device including:
a first waveguide;
an optical resonator that is coupled to the first waveguide;
a first light source that introduces first light into the first waveguide; and
a second light source that irradiates the optical resonator with second light,
wherein
the optical resonator includes a second waveguide that extends in a first direction and a color center that is provided in the second waveguide,
the second light source has an optical axis in a second direction perpendicular to the first direction, and
the color center is irradiated with the second light.
